(19) United States
(12) Patent Application Publication
(10) Pub. No.: US 2023/0184239 A1
(43) Pub. Date: Jun. 15, 2023

(54) SYSTEM AND METHOD FOR ROD PUMP AUTONOMOUS OPTIMIZATION WITHOUT A CONTINUED USE OF BOTH LOAD CELL AND ELECTRIC POWER SENSOR

(71) Applicants: Jesus S. Armacanqui, Houston, TX (US); Paul A. Munding, JR., Houston, TX (US); Nick Martin, Houston, TX (US)

(72) Inventors: Jesus S. Armacanqui, Houston, TX (US); Paul A. Munding, JR., Houston, TX (US); Nick Martin, Houston, TX (US)

(73) Assignee: Gas Lock Eliminator, LLC, Houston, TX (US)

(21) Appl. No.: 18/064,887

(22) Filed: Dec. 12, 2022

Related U.S. Application Data
(60) Provisional application No. 63/288,203, filed on Dec. 10, 2021.

(51) Int. Cl. F04B 49/06; G05B 13/02; G05B 19/05; F04B 47/02

(52) U.S. Cl. CPC F04B 49/065; F04B 47/026; G05B 13/0285; G05B 19/05; G05B 2219/15053

(57) ABSTRACT

A method, a computer program product, and a system for pump control that incorporates software algorithms, artificial intelligence, subject matter expertise and hardware for the autonomous optimization of a rod pump in a producing oil well, including various systems. The subject of the invention that is named here The Rod Pump Surveillancer System, is a built in a Pump Controller and integrates themodels for generation and diagnostic classification of dynamometer cards, the Neural Fuzzy Logic Algorithm for a programmable logic controller functioning stand alone, or connected to an edge computer, a server at the office or in the cloud, and the program software for the Human Machine Interphase. The method includes a developed model to generate downhole dynamometer cards based on data from two sensors. A programmable logic controller and a Human Machine Interphase device is used to further enhance control capabilities.

### CROSS REFERENCE TO RELATED APPLICATIONS

This application claims the benefit of an earlier filing date and right of priority to U.S. Provisional Application No. 63288203, filed 10 Dec. 2022, the contents of which is incorporated by reference herein in its entirety.

### BACKGROUND OF THE INVENTION

### 1. Field of the Invention

The present application is an invention that relates to optimization of crude oil extraction from production wells, and more particularly to a method, system and computer implemented process or computer program product that enables the generation of dynamometer chards as well as the diagnostic of the operational condition thus determining the performance for a rod pump artificial lift system and the autonomous optimization of the operation of the existing pump and supporting the design of a new pump. Further this invention also supports the online optimization of the integrated production system. Further this disclosure relates to a pump controller that utilizes the acquired advantages of the presented invention.

### 2. Description of Related Art

When natural energy of the reservoir declines in an oil producing well to the point that production flow to the surface ceases, then artificial lift systems are required, among them the Sucker Rod Pumps. Due to its initial and maintenance costs, simplicity and familiarity of the staff, worldwide, it is the largest artificial lift system currently in use.

The Energy source to power the pumping unit or the prime mover is either an electric motor or an internal combustion engine run on natural gas or other type of fuel, such as propane and diesel fuel. It produces a rotating motion, that is converted by the pumping unit into a reciprocating pump action. The crank bar, the walking beam, and the horse head transfer this energy in the form of a vertical up and down movement to the polished road that is connected to the sucker rod string, that in turn transfer this energy to the down hole mechanical pump, as observed in the FIG. , 1. In wells with an electric motor a Variable Speed Drive - VSD may be used in order to change the speed of the motor and therefore reduce or increase the Strokes Per Minute - SPM of the pumping unit.

Production optimization includes the pump performance, yet it goes beyond it. In fact, the Artificial Lift System is one subcomponent of it only. The other two components are the Reservoir-Well Subsystem, called also the Inflow, and the flow conduit features, known also as the Outflow. These three components build the concept of the Integrated Production System (IPS).

The Reservoir -Well Subsystem, or Inflow, is represented by the capability of the reservoir to deliver an amount of oil (in barrels of oil per day - bopd) into the well at the depth of the completion, e.g. perforation interval. This depends on the permeability of the reservoir, the reservoir pressure and the skin factor of the borehole near area, as well as the wellbore radius. A more common term for this is the inflow capacity of the Reservoir and mathematically it is described by the Inflow Performance Relationship - IPR, that relates the static (Psta) and the well flowing pressure (Pwfl), and in psi at the level of the perforations, the produced rate (Qoil) in bopd and the bubble point pressure (Pb) in psi.

In practical terms the Outflow is the required pressure at the discharge of the pump that is needed to lift the oil rate up to the surface, which depends on three factors:the pump set depth, the pressure losses due to the friction and the pressure at the well head (Pwh). The third subcomponent of the IPS is represented by the Artificial Lift System, e.g. the Rod Pump, whose performance depends on the pump design and on the actual operating conditions. All the three subcomponents of the IPS are in continuedinteraction at any point on time, down from the reservoir up to the surface lines at the point of delivery to the separator.

Performing optimization in the Integrated Production System (IPS) requires analytical equations or numerical models and more importantly specific data of the key describing parameters as indicated in [0004]. Among the used tools are the sensors installed on the surface and down hole, well test measurements, fluid sampling, the Fluid Level Tool Survey - that enables determination of the fluid level and therefore of the flowing pressure Pfl while the pump is shut in or in operation. The Dynamometer Chart -DC has been primarily used to identify any abnormal pumping condition, providing qualitative information mainly, yet it is a crucial tool to monitor the pump operation.

Dynamometer Charts are very helpful means for the diagnostic of pump performance. The dynamometer is a device that measures rod loads against the rod displacement during an entire pumping cycle. This results in a closed load-travel diagram for each cycle, thus capturing all the acting forces on the pumping process. Therefore, it enables the evaluation of the performance of the down hole pump, the sucker rods, and the surface pumping unit. The outcome of this DC evaluation make it possible the optimization of the pump operation and the detection of any abnormality and therefore prevention or detection of any potential failure of the rod pumping system, prior to its occurrence. Among the qualitative features that can be detected by a DC are those conditions related to normal operation or resulted from expected normal wear and tear, however more interesting are abnormal conditions that could affect the pump operation such as fluid pound - when the pump cylinder is partially filled, gas interference, gas locking, leaking or stuck valves - traveling or standing one, parted sucker-rods, presence of emulsions of high viscosity, worn pump, reduced tuning diameter, among others.

In the early years the portable Dynamometer Instrument that recorded the instantaneous polished rod load throughout the working cycle of the pump that resulted in the DC, was carried from well to well by field staff. The frequency of the DC recording - e.g. daily weekly or monthly, was determined by the importance of the well and the assessed criticality of the problem. In any case it was a time consuming yet necessary activity, that involved deployment, connection, and stowing cables and a subsequent interpretation of the DC.

The latest technological development has led to the capability to take the DC ona continuous basis, resulting in important improvements in the pump operation. However, this shift from a sporadic to a continued DC recording and therefore monitoring of the operation has additional associated costs what has constrained its use to the high profile wells only, within the field. These systems commonly use the rod force sensor called also Load Cell Sensor and either an inclinometer or a proximity sensor to determine the position of the polished road. Thus with the load and position cells the Dynamometer Cards are continuously obtained, without human intervention.

The use of the Load Cell sensor has a few disadvantages, among them the initial large investment for equipment acquisition, installation and maintenance. Particularly cumbersome is the difficult calibration procedure and the temperature adjustments that has to be done on a regular basis (AU2015229199B2). Additionally, the electronic devices are subject to a harsh environment whereby the dynamic of the changing load in every pumping cycle puts the system on stress. These factors have further constrained the use of the continued recording of the dynamometer cards mainly to the high profile wells. (CA3075709A1) utilizes a strain gauge that is adapted to measure axial load on a polished rod of a pump jack, and the accelerometer or an inclinometer that is adapted toindicate displacement of the operating rod. (US5464058A) also includes strain gauges for measuring the load on the rod. However, strain gauges have limitations in terms of fatigue, and the measurement environment, as they are sensitive to temperature changes requiring calibration on regular basis.

Above limitations have triggered the search for alternative solutions to the use of load cells. One of these incorporates the use of a power sensor that measures the instantaneous power consumption of the rod pumping system per each cycle. (US6343656B1) and (SPE-196159-MS) show two cases of this approach, both cases use mathematical models based on a neural network to determine the DC relationship from the power consumption of the rod pumping system.

In (US6343656B1) the instantaneous net torque per cycle is determined from the power consumption, based on this the surface dynamometer relationship is determined; then over the wave equation the down hole DC is calculated. (SPE-196159-MS) presents the application of artificial intelligence technology to generate the DC directly using electrical power curves. It reports above 90% similarity compared to the real DC. The card generation model is stable, preventing the disturbances of operational conditions and sensor operation. However, based on the presented cases of comparison between the real measured and the predicted DCs, the used deep learning model may mask key operational details due to the applied data smoothing. On the other side, in practical field operation sometimes the power consumption signal can be affected by electrical interference and disturbances, therefore introducing some discontinuities, regardless if those are smoothed for the analysis, Further This could limit the use of the predicted DC for quantitative calculations.

While using the electrical current for continued DC recording may be a viable option as shown by (US6343656B1) and (SPE-196159-MS), the required data is not always available, e.g. when gas driven systems are utilized. In practical field operation, often times there is no electrical power at the well site and the pumping units are driven by gas motors. Giving that commonly casing gas is available in the same well, it is more affordable and attractive to go for gas as the prime mover. In fact, there are entire fields where all the rod pump systems are operated by gas combustion motors, therefore in those wells the said option of recording the DC based on the current is not possible. On the other side (US20170306745A1) utilizes sensors comprising at least an accelerometer and a gyroscope being attached to a crank arm of the pump jack. However, in practice it is not rare that a pump jack operates in out of balance conditions that create stress on all the components including the crank. In fact, during pump jack operation the crank components such as the pin can be displaced on axial direction, due to either a load that is too high or too low, or due to faulty pin or the mentioned unbalanced pumping condition, what could influence the data from the sensor attached to the crack.

Upon continued recording of the DC based either on the load sensor or derived using the power consumption, the right and timely fast diagnostic can translate in faster response in terms of production increase or preventing a failure and therefore deferment, however the proper diagnostic requires specific expertise to analyze the recorded DCs -given that different shapes of the DC represent different pump conditions. A misjudgement or wrong diagnostic of the DC can lead not only to fail preventing a premature failure - with the associated Work Over cost, but also to missed optimization opportunities. The skills for the right interpretation of the DC require over many years of field experience. As the recording of the DC actually occurs on the surface at the polished rod, first a conversion to the conditions down hole is required. This has been solved by applying mathematical algorithms such as the wave equation model to determine the downhole dynamometer relationship, as indicated by Gibbs, S.G. (1963). Following factors need to be taken into account: elasticity, lengths and diameter sizes of the sucker rod string, as well as friction effect, among others.

After the generation of the DC on a continued basis, using the measured load either by a load cell, load sensor or a strain gauge or using power consumption data and a polish rod positioning or displacement sensor, the shape of the DC is interpreted by the Expert to evaluate the performance of the rod pump system. More recently the most advanced systems of continued DC recording also enable an automated diagnostic using different techniques to recognize the specific undergoing condition in the rod pump system. Among them are, deep learning neural networks such as Convolutional Neural Network (CNN) for image recognition (SPE-196159-M) or the use of other feature engineering techniques (SPE-194993). These automated diagnosis deep learning models and feature engineering procedures require from thousands of dynamometer cards labeled with different classifications, what require of a sizable real DC Data Base evaluated by subject matter experts, and of high end computing processing capabilities, with the associated costs.

Above two features, a) the continued generation of DC and b) the automatic diagnostic, have been incorporated in the latest advanced Pump Controllers that are installed right on the well site, next to the rod pump surface equipment. Common denomination of those are “Pump Off” Controller that highlight one of the key features of the Controller that is to stop the well if a condition of pump sets in and is automatically detected, as opposed to the traditional clock based mechanical pump off switch manually adjusted by the well technician.

Some of the most advanced Pump Controllers are designed to also support the Well Production Optimization that requires the use of the information from the DC along with the use of data from other sensors that are installed on the surface and down hole. Often these Controllers heavily rely on the down hole parameters that are subject to failure. Among these down hole sensors is the sensor that measures the Pwfl - the wellbore flowing pressure that is a key parameter that to calculate the inflow performance relationship - IPR of the Well-Reservoir System, as described in [0005]. As an alternative to obtain the Pwfl data, measuring the fluid level over the pump in the annular space by means of the Fluid Level survey is of common use, however the use of it follows a planning, requiring mobilization of the tool and the Technician to the site with the associated costs.

Further the real well production operation includes the risk that the assets are deployed in isolated areas where they are not guarded on a continuous basis. Installing high value electronic components may lure unwanted visitors that may end up dismantling the Pump Controller.

There have been many attempts to solve the problem of obtaining representative Dynamometer Charts - DC on a continuous basis and perform optimization of the rod pump system. Thus, it can be appreciated that there is a need in the art for a system and method to overcome the identified shortcomings and gaps in order to improve the use of the sucker-rod pump system and assist operators. These gaps are specifically related to the below aspects.

A) The lack of a method for continuous recording of the DC that is based on a sensor that is not subject to frequent maintenance and calibration as opposed to the load cell sensor or to disturbance and interference exposed power consumption sensor, and that can be used not only for electrical prime drives, but also for gas or prime drives.

B) The lack of an automated DC recognition method using a proper DC classification that identifies the actual operating condition of the rod pump system using models that are accurate, yet with low computing capacity requirements, and that can be carried out on real time in a cost effective and reliable manner.

C) The Lack of a method that enables the real time determination of the wellbore flowing pressure Pwf without the need of down hole sensors nor from a fluid level survey. Measuring the Downhole flowing pressure - Pwf in real time implies installing downhole sensors, during the installation of the production completion or running a wire line pressure survey, what is associated with additional costs and damage, due to either sensor malfunctioning or disruption in the communication. On the other side in the traditional Echometer Method [3]. the problem of large noise disturbance, weak echo signal, and difficult identification of liquid level wave impacts in the accuracy. While other methods have been proposed such as the use of the column sound field model [4], still this is plagued with a 2% accuracy what in a fluid level value of 3,000 feet amounts to about 30 psi what translates in a few barrel of missed of oil production. Thus there is a need for the determination of the Pwf that does not depend on down hole sensors nor of other type of sporadic fluid level surveys, rather to have the capability to determine the fluid level when it is needed, while the rod pump is in operation.

D) Latest generation Well Controllers are heavily focused on the rod pump system using the info extracted from the DC and data from both the surface and down hole sensors. The downhole rod pump is actually just a subsystem of the three subsystems of the Integrated Production System. the others being the Well-Reservoir System - called also the Inflow, and the Outflow System. The Inflow Subsystem depends on properties related to the well and the reservoir such as the well radius, the rock permeability, the skin factor and the crude oil properties, like the Bubble Point Pressure -Pb. The term Inflow also refers to the Inflow Relationship that is calculated using the static and flowing pressure, the fluid rate and Pb.

The Outflow Subsystem is comprised by, the rod string, the tubing, the surface flow lines, and valves placed in between such as the choke valve. The term outflow also refers to the pressure that is demanded at the outlet of the pump - at the pump discharge. When a pump is producing at certain rate, this actually means that all three subsystems are in a certain energy balance - equilibrium. Therefore, the downhole rod pump is actually in continued interaction with the other two subsystems, changes on any of the two others will impact the pump performance, however mostly remain unnoticed, due to over focusing on the rod pump system only. One of the reasons for this observed neglect of the other two subsystems is the perception that apart from the downhole pump system - that is related with the Artificial Lift Concept, the other subsystems are more associated with Production Operations - the Outflow Subsystem, and with Reservoir Engineering -the Inflow Subsystem. Thus, when the Pump Controller focuses on just one of the subsystems, it results in missing improvement opportunities for the online optimization of the integrated production system.

E) Latest Pump Controllers incorporate algorithms that use information and data sourced from the DC, and from sensors installed on the surface and downhole as input, in order to perform the pump controlling functions. While they can perform well, as long as the sensors are working fine, in case of sensor malfunctioning, the right operation control is exposed. If the sensors are located on the surface, they can be repaired or replaced, however for sensors installed downhole the problem remains unsolved. If the pump controller algorithms fully rely on this downhole data, then the pump operation and control can be affected. The harsh operating downhole environment and the nature of the electronic devices and any mechanical stress during installation (running in the hole) increases the possibility of sensor malfunctioning and of a negative impact on the pump controller performance.

F) In real oil fields, after few years of operation. it is very common that only a fraction of the wells concentrates the majority of the field production while most of the wells produce far below the average. On the other side, in old fields, the stripper well type wells produce at marginal rates of few barrels per day. Under above conditions investing for a full-fledged Pump Controller for all the wells is rather a good aspiration. Therefore, a differentiated approach is required in terms of optimizing and automating the rod pump operation in low to very low oil producing wells as compared to the high or very high producing wells. In [0037] and [0038] viable alternatives are presented to this problematic.

G) The use of autonomous systems to operate rod pumps is often times limited by the absence of control devices on the well site, that enable the complete automatic adjustment of the operating parameters according to the determined values carried out by optimization models. This impacts not only in the actual operation of the rod pump but also constrains the further development of the appropriate hard and software tools for a broader autonomous operation, missing a further improvement of the rod pump operation and optimization of the integrated production system.

Although strides have been made, shortcomings remain.

### BRIEF SUMMARY OF THE INVENTION

It is an object of the present invention to provide a system and method whereby reliable DC can be obtained in a continuous basis and cost effectively, for wide use to optimize and enhance production from rod-pumping systems without the aforesaid difficulties with the goal that this system can be utilized in all the wells of the field including the low producers regardless of the prime mover - either electrical or gas powered.

The present application presents an alternative method for the continued generation and recording of DCs as well as its automatic classification, based on the analysis of the acceleration of the polished rod through the use of artificial neural networks. The presented neural network model is implemented as a robust, yet low-cost system designed on data recorded from the inertial Accelerometer sensor and using microcontrollers installed on the well site for either remote monitoring or autonomous operation. For this reason, the neural network architecture was designed with a reduced number of layers, as described below.

(A) In the present invention a system and method for continuous recording of the Dynamometer Chart - DC has been developed. This system and method is based ondata from the Accelerometer sensor attached at the polished rod and of a rod positioningsensor Inclinometer comprised of a Gyroscope and an Accelerometer, located on the horsehead. It is to note that the Accelerometer is a sensor that is not subject to frequentmaintenance and calibration as opposed to the load cell sensor or to the disturbance exposed power consumption sensor, and that can be used not only for electrical prime drives, but also for gas prime drives, as it is attached to the polished rod.

The referred system and method in [0029] utilizes data from the Accelerometer sensor that is a robust inertial sensor that is attached to the polished rod of the rod pump and data from the inclinometer. Both sensors are of commercial use, and familiar to the person skilled in the art.

The data recorded by the accelerometer sensor is processed using the neural network architecture with a reduced number of layers. For the dynamometric chart approximation or generation, first, the data was normalized, then a feature extraction was applied using PCA (Principal Component Analysis). The neural network has four layers, the initial layer is built with the input of the preprocessed data and the normalized position data, with a ReLu activation function, further two hidden layers, normalized by batch with the activation function ReLu and finally an output layer of 300 neurons containing the values calculated with a sigmoidal activation function. As the Loss Function, the MSE (Mean Squared Error) was used, as metric the MAE (Mean Absolute Error) and the Adam Optimizer with a learning rate of 0.001 for 150 epochs. In the first stage, the neural network is trained with acceleration and position records of the individual strokes and the load as an output variable, in this way the neural network model is obtained out of the learning sequence to reconstruct or generate the DC.

(B) The present application presents an alternative method for the automated DC recognition method using a DC classification that identifies the actual operating condition of the rod pump system in a reliable manner. For the classification neural network model, the pre-processed acceleration and position data, as recorded by the Accelerometer and Inclinometer sensors respectively, were used as inputs in the first layer, Further, two hidden layers were used with the activation function ReLu and a dropout of 0.25 and finally an output layer with a “Softmax” trigger function. As Loss Function, the “Categorical Cross-Entropy” was used, as an accuracy metric, and the Stochastic Gradient Descent SGD as optimization algorithm for 400 epochs. After the dynamometric chart - DC is obtained by the first model as explained in [0031], it serves as an input to a second network whose variable is to predict the classes selected manuallyby the operator, thus allowing the network to learn to classify according to the trained conditions.

Both the DC generation and the automated diagnostic can be carried out using models that are accurate, yet with low computing capacity requirements, and that can be performed on real time in a cost effective manner. The probability of the classifications for the different pumping conditions ranges from 92% to 98%, thus providing a robust method for the resulting DC and its diagnostic, using data measured with inertial sensors, Accelerometer and Inclinometer.

C) In this application a method is presented that enables the determination of the wellbore flowing pressure Pwf on real time without the need of downhole sensors nor from fluid level surveys. The determination of the Pwf is carried out using the generated and classified DC for the case of the fluid pound in the downhole rod pump.

D) In the present invention a method is applied that enables the optimization of the Integrated Production System using the information extracted from the DC and data from sensors installed on the surface, thus going beyond the rod pump system. Giving that the downhole rod pump is just a subsystem of the Integrated Production System and is in continued interaction with the other two, the others being the Well-Reservoir System - called also the Inflow, and the Outflow System, changes on any of the other subsystems - that remain unnoticed, due to over focusing on the rod pump system only, will impact on the pump performance, thus missing improvement opportunities. FIG. 4 shows a schematic of the pressure Drop occurring on the said three Subsystems. In this application a method is presented that enables the optimization of the integrated production system that takes advantage of the generated and classified dynamometer cards that enable identification of a number of abnormal conditions or anomalies in the pump operation that affect or are caused by the other subsystems of the integrated production system IPS, as described in the detail description section.

E) In this application for the purpose of a reliable pump controller operation an algorithm is used that is based on parameters measured in the surface sensors only. The data sourced from downhole parameters such as the downhole pressure, temperature or flow rate is done on an optional basis only, and as secondary reference parameter with no effect on the pump controller operation.

F) As described in the prior art [0024] it becomes evident that for low to very lowoil producers less costly, yet robust rod pump controllers are required. In this applicationa method is presented that enables the configuration of a Pump Controller that is based on a scalable application embedded in Internet of Things - IoT type equipment that is robust, accurate and is driven by a software that can be operated at the site using Artificial Intelligence - AI as described in [0059], that yields accurate results, yet are run on devices with low computing capacity requirements such as microcontrollers, alternatively it can be also run in the cloud or in other external server.

G) In the present application the preferred embodiment incorporates an additional control device to the rod pump system, besides the use of the Variable SpeedDrive - VSD, specifically a choke valve with an actuator on the flow line that is connectedto the tubing side. Further the choke size and the differential pressure across the choke are added to the other surface parameters and the information derived from the generatedand classified dynamometer card according to [0059], to serve as input to the ComputerProgrammable Unit - CPU. The use of a Process Logic Control - PLC, Ethernet and Human Machine Interphase - HMI display enables the autonomous operation, monitoring,troubleshooting and optimization of the rod pump system.

In the present application the said inventions are incorporated in the algorithm that is utilized in the described Pump Controllers, the one for the low to very low oil and the one for high oil rates respectively. Further in the present application the preferred embodiment is described in [0064], because it yields the full advantage of the autonomous operation given the incorporation of control devices, such as VSD and a choke valve and fitted with an electrical, pneumatic, or hydraulically controlled actuator. The presented invention includes, a system that it is called here the Dyna Chart App, composed of hardware and software modules that allow the generation of dynamometer charts and its automatic classification using data of both the acceleration and the position of the polished rod. Adding the outcome from the dynamometer cards to other data from surface sensors into a fuzzy logic algorithm results in an advanced pump controller that is called herein as Rod Pump Surveillancer - RPS, given that it incorporates the analytical capabilities of a Surveillance Engineer at the well site.

The incorporated algorithm and control components enable a local operation as well as a remote one, or both. For the remote operation the data can be transmitted via internet, wifi or radio. For well locations where there is no internet connection at the site, a Low Power Wide Area Network (LPWAN) protocol such as the LoRaWAN™ is utilized, which supports low-cost, mobile, and secure bi-directional communication for Internet of Things (IoT), machine-to-machine (M2M), and other industrial applications. On the other side it also provides full end-to-end encryption for IoT application.

Ultimately the invention may take many embodiments. In these ways, the present invention overcomes the disadvantages inherent in the prior art. The more important features have thus been outlined in order that the more detailed description thatfollows may be better understood and to ensure that the present contribution to the art isappreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of beingpracticed and carried out in various ways. Also it is to be understood that the phraseologyand terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 illustrates a rod pump system with surface and downhole components, including the sensors incorporated in the present application, located on the polished rod and on the horse head, as per the preferred embodiment.

FIG. 2.1 illustrates the involved hard and software of the dynamometer card generation and diagnostic classification in accordance with the preferred embodiment of the present invention. FIG. 2.2 describes the conceptual workflow of the data streams of the present application. FIG. 2.3 shows a workflow of the data sets for Training and Testing of the model for the Dynamometric Chart Generation.

FIG. 3 illustrates a Schematic of the pressure drop on the three subsystems of the Integrated Production System (IPS).

FIG. 4 illustrates the Architecture of the identification of Equipment Anomalies and Production Improvement Opportunities as incorporated in the present application.

FIG. 5 illustrates the schematic of the architecture of the Microcontroller based Pump Controller showing the components of the Rod Pump Surveillancer - RPS System.

FIG. 6 illustrates schematic of the Architecture of the CPU - PLC - HMI based Pump Controller showing the components of the Rod Pump Surveillancer - RPS System, according to the preferred embodiment of the present invention.

FIG. 7 Schematic of the Human Machine Interphase - HMI Display of the Rod Pump Rod Pump Surveillancer - RPS System.

FIG. 8 depicts the Data Transmission set up and Data Traffic Protection, according to an embodiment of the present invention.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer’s specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The method in accordance with the present invention overcome one or more of the above-discussed problems associated with performing the generation of the dynamometer cards and the automatic event diagnostic. In particular, the system and method of the present invention based on the accelerometer inertial sensor by the use of machine learning techniques for rod pump systems to generate and classifydynamometer cards for wells with electrical or gas motor prime in a reliable and cost effective manner.

Prior attempts to resolve the generation of dynamometer cards without the use of load sensors or load cells have different limitations. On one side the disturbance and interference affecting the power consumption or current sensor, on the other side the inability to use it for rod pump systems based on gas motors. Further the generation and classification of dynamometer cards by means of mathematical algorithms such as neural network demands from a large data base which requires large computing capability, In contrast, the presented method and assembly utilizes inertial sensors such as the Accelerometer and the Gyroscope that are robust and reliable and are not affected by electrical disturbances, Further the utilized workflow is based on models that are accurate, yet with low computing capacity requirements, and processing can be carried out on real time in a cost effective and reliable manner.

In general, the method presented herein may be applied to both, conventional oil wells and unconventional shale oil wells, unconventional wet gas or gas condensate (retrograde gas) wells, coalbed methane wells, conventional oil wells, and conventional wet gas or gas condensate (retrograde gas). The method may also be applied to both land and offshore wells. Furthermore, the well can be vertical, horizontal, multilateral, stimulated with a single/multiple fracture(s) or chemically stimulated, or both. The incumbent well can be an existing well or a recently or new to be drilled well.

The method disclosed herein can be used in wells that are using sucker rod pumps such as the traditional oil well pump jacks, long stroke pump systems, such as theRotaflex type, linear rod pumps such as the LRP system.

The method and system will be understood from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application,even though not all variations and particular embodiments are shown in the drawings. It also should be understood that the mixing and matching of features, elements, and/or functions between various embodiments are expressly contemplated herein so that one of ordinary skill in the art would appreciate from this disclosure that the features, elements, and/or functions of one embodiment may be incorporated into another embodiment as appropriate unless otherwise described.

The system of the present application is illustrated in the associated drawings. As used herein, “system” and “assembly” are used interchangeably. It should be noted that the articles “a”, “an”, and “the”, as used in this specification, include plural referents unless the content clearly dictates otherwise. Additional features and functions are illustrated and discussed below.

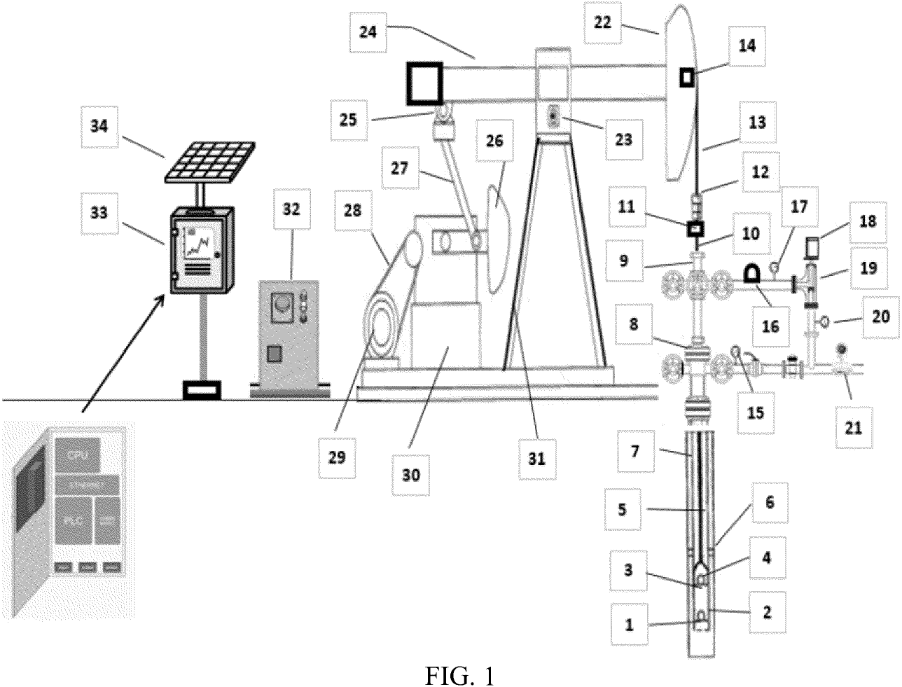

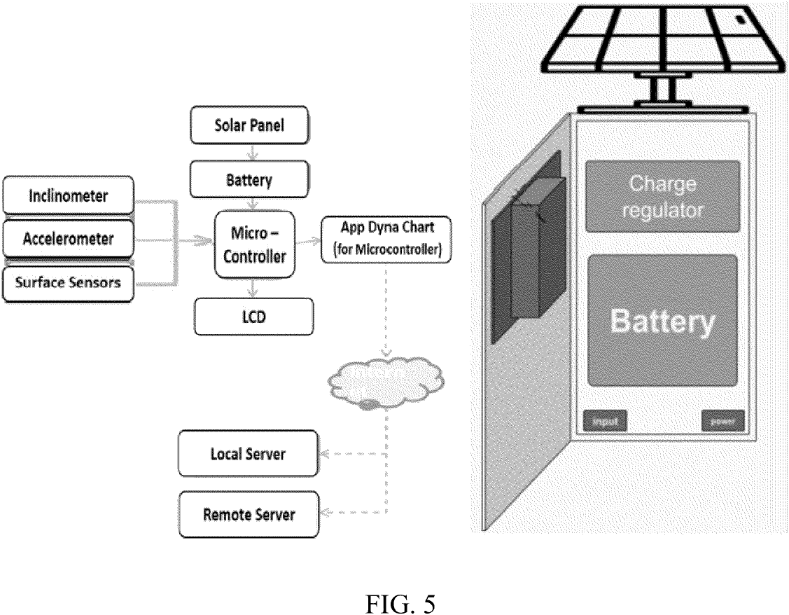

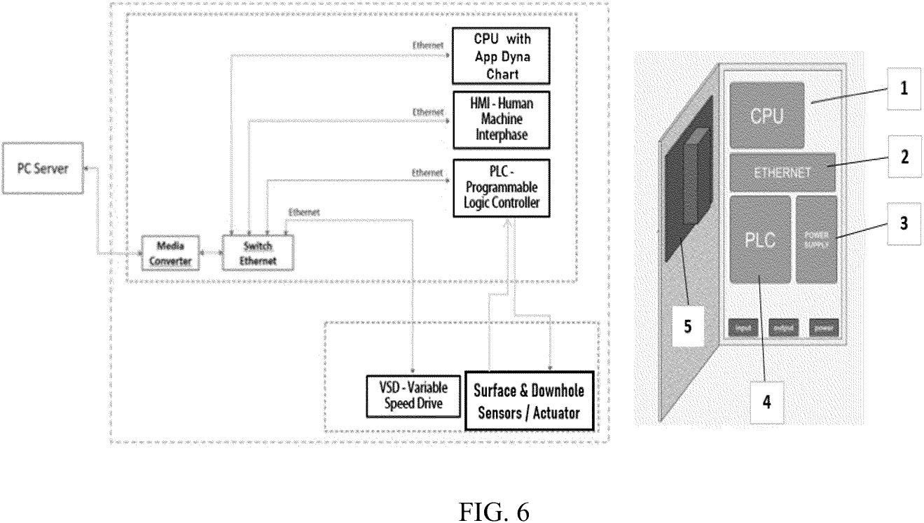

Referring now to FIG. 1, a Rod Pump System environment is depicted including both the surface and the downhole components. The pump action that lifts the oil up to the surface is caused by the reciprocating movement of the rod pump plunger 3 inside the cylinder 2 that triggers the sequential opening and closing of the standing 1 and traveling 4 valve respectively. The energy generated on the surface is transferred via the polished rod 10 and the sucker rod string 5 to the plunger 3 of the pump that is tied by the pump anchor 6 to the tubing 7. The energy generation is done by the prime mover 29 that over the reduction gear 28, the crank 26, the equalizer pitman 27, the walking beam 24, the horse head 22 and the wireline 13, the polished rod hanger 12 is transferred to the polished road 10 and further below up to the plunger 3. Further in the present inventiontwo inertial sensors are incorporated as follows. First the acceleration of the polished rodis measured by the accelerometer 11 and the accurate position of the walking beam and therefore of the polished rod is determined by the accelerometer and the gyroscope called also positioning sensor 14. The recording of the readings of the sensors 11 and 14 provide the input data to generate and classify the dynamometer card using artificial intelligence as described below. In the present invention the preferred embodiment considers the use of a Pump Controller 33 - that is further described in FIG. 5 and FIG. 6, and of a Variable Speed Drive - VSD 32, along with a choke valve 19 and an electronic actuator 18, as depicted in FIG. 1. Among other surface components of the Rod Pump System are the well head 8, stuffing box 9, casing pressure sensor 15, high resolution Microphone 16, well head pressure sensor 17, flow line pressure 20, flow rate meter 21, saddle bearing 23, equalizer bearing 25, reducer sub-base 30 and the Samson post 31.

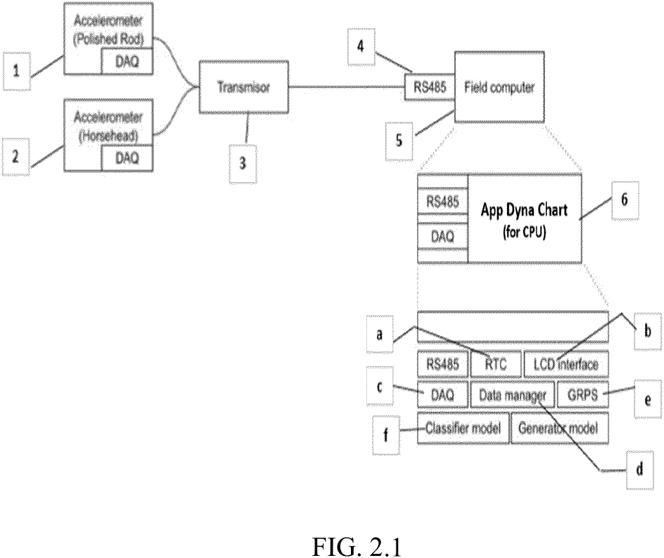

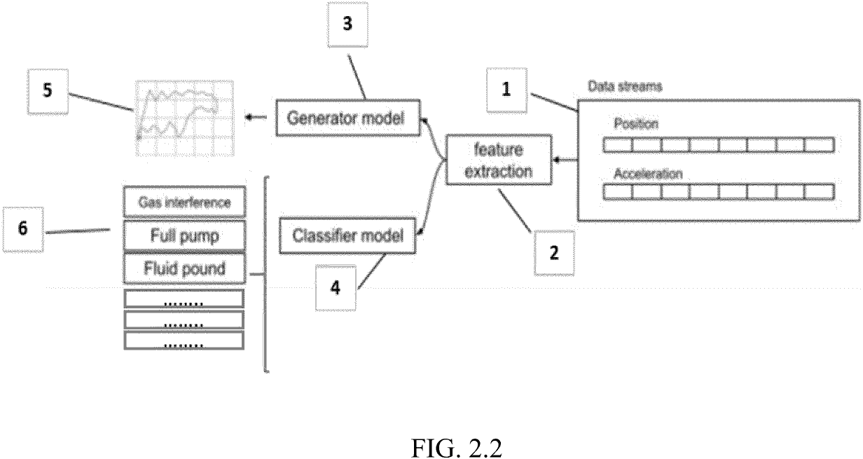

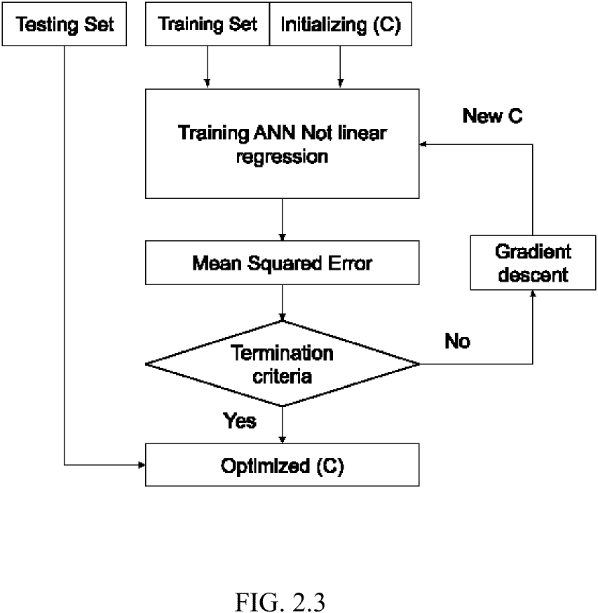

Referring now to FIG. 2.1, a functional block diagram illustrating the dynamometer card generation and diagnostic classification of the presented application, as described below. It is to note that this figure provides only an illustration of one implementation and does not imply any limitations with regards to the environments in which different embodiments may be implemented. Many modifications to the depicted environment may be made by those skilled in the art without departing from the scope from the invention as recited by the claims.

1 shows an Inertial Measurement Unit - IMU, composed of an Accelerometer to obtain the linear acceleration in the z axis of the polished rod, in a range of -3G to 3G with a resolution of 16-bit ADC. It has an acquisition system that allows to register up to 600 samples per second, it uses the I2C protocol for data transfer to the microcontroller (transmitter).

2 shows an IMU (Inertial Measurement Unit) composed of an Accelerometer and of a Gyroscope to obtain the position of the polished rod with respect to the lowest position. This is carried out by combining the acceleration and the angular velocity in the Y axis. It has an acquisition system that allows recording up to 600 samples per second, it uses the I2C protocol for data transfer to the micro-controller (transmitter).

3 depicts a Microcontroller that performs the reading of both sensors 1 and 2, further it performs the data pre-processing for the acceleration and the position as well as the extraction of the main characteristics, by dividing the recorded acceleration data into four blocks, then it transfers the information through the RS485 protocol to the field computer 5.

4 is a Module that uses the RS485 communication protocol for data transfer and reception, further it allows connectivity by wiring up to 500 meters of distance between the sensors and the field computer.

5 is a computer Processing Unit - CPU, called here also a Field Computer that receives data serially using the RS485 protocol, it has an acquisition module that synchronizes the request and reception of data. This information is used by the application, called here - App Dyna Chart depicted in 6, that is installed in the CPU. This is a system composed of hardware and software modules that allow the generation of dynamometer charts and its automatic classification using data of both the acceleration and the position of the polished rod. A CPU version is utilized whose modules are described as follows:

(a) The Real Time Clock - TRC, that allows to make a temporary trace to the register, for both, the classification and for the generation.

(b) The liquid-crystal display - LCD interface, that allows to view in the field the system data, such as time, date, the dynamometer card, the classification, the recommendation and the historical events of the day.

(c) The data acquisition module - DAQ that allows the synchronization of the request for information and the reception of data from the sensor.

(d) The Data Manager, is a software module that allows managing the information (position and load), and communicates with the cloud or the local processor in case the models are run locally.

(e) The Communication Module, e.g. General Packet Radio Service - GRPS is a transmission module that uses the 3G cellular network to transmit and receive information from the cloud. It can transmit the raw information to be processed in the cloud or the processed information in data packages (local processing).

(f) The two Artificial Intelligence - IA Generation and Classification Models, that have been implemented in the present application, can be executed in the cloud or locally, and are in charge of processing the information from the Data Manager, having as input the vector of acceleration and position characteristics.

Referring now to FIG. 2.2, a conceptual workflow is described in the following lines. 1 depicts the Data Streams which is the raw data for acceleration and position thatis recorded - as shown in the module 1 and 2 of FIG. 2.1. From the entire register only one stroke is extracted according to the position register, this stroke is divided into four blocks with the same number of records each, from each group the main characteristics are extracted, which are inputs for both models - the Generation and the Classification Models. Thereafter the feature extraction is carried out 2. The Generation Model is represented in 3, that has as input the vector of characteristics from the previous block 1 and based on that reconstructs a vector of 250 points that corresponds to the normalized load of the plunger (0 - 1) and with the vector of position of the pump plunger, together they allow to reconstruct the dynamometer card. 4 represents the Classification Model, that has as input the vector of characteristics from block 2. It allows the prediction of the type of dynamometer card from the data recorded for the acceleration and position. This model was trained based on data available for the different operational conditionswhereby each dynamometer card used for training was manually labelled according to the input of a subject matter expert.

5 depicts the dynamometer card that is generated by the model which isdisplayed on the LCD on the field pump controller, in the cloud and, or on the web server.6 depicts the classification of the model generated dynamometer card that is displayed on the LCD on the field pump controller, in the cloud and, or on the web server.

Referring now to FIG. 2.3, a functional block diagram illustrates the Dynamometric Chart Generation as described in the following lines. The Training Set contains data of the time, the acceleration, the load, of the positioning and the tag of the occurring operational condition of different Wells. In the Initialization the weighting factorsof the network are randomly generated. The Training of the Artificial Neural Network - ANN Not Linear Regression module, implies entering of the normalized and pre-treated data (Vector of features) and the use of the Mean Squared Error as the Loss Function (Root Mean Square Error) that serves as measure on how close it is to the real curve. Inthis Workflow the Gradient descent serves as an Optimizer that corrects the original weights in such a way that as time passes the error decreases. As Termination Criteria either a certain number of epochs or the stability of a low value of the error are chosen. Upon achieving the Optimized (C) the testing phase starts using Testing Data Set that contains data of the same type then the training set, yet from other pool of selected wells.

The Classification of the generated Dynamometric Chart is carried out in a similar way than in the Generation Phase, except the training for the multi label classification whereby as the Function Loss the Categorical cross entropy by means of a matrix, instead of the Mean Squared Error, is utilized.

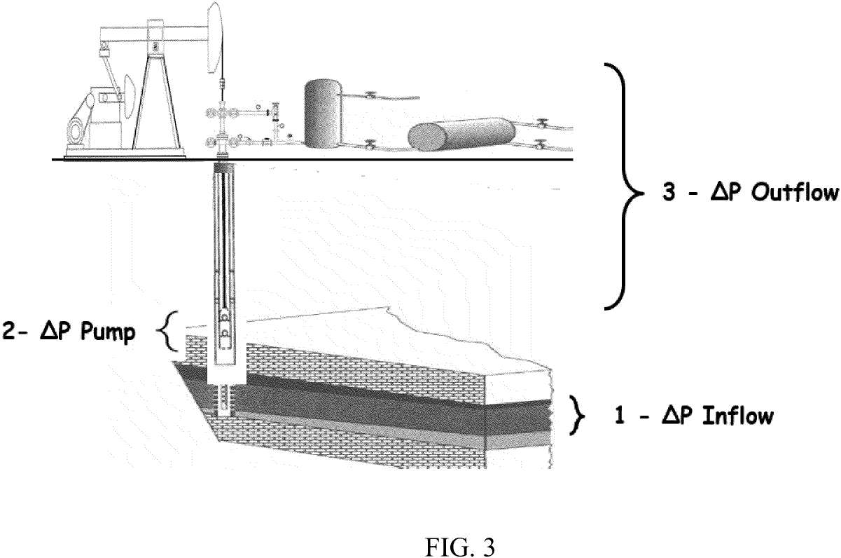

In the present application a method is presented to determine the wellbore flowing pressure Pwf on real time without the need of downhole sensors nor from fluid level surveys. Upon the generation and classification of the DC and therefore determination of the pump operating condition as explained in [0059] the actual fluid levelin the casing annular can be indirectly measured by means of the identification of the case of “Fluid Pound”. This actually starts occurring when the fluid in the pump cylinder is below the travelling valve, leading to a partial filling of the pump. The developed modelidentifies the point on time when this condition occurs and use the set depth of the travelling valve to calculate the actual fluid level. Further operationally the Stroke per minutes - SPM will be adjusted so that the fluid level stabilizes with a low level of fluid pounding for the duration of a representative well test. Alternatively, the fluid rate can becalculated with the use of a standard Nodal Analysis that incorporates all three subcomponents of the Integrated Production System - IPS, as showed in FIG. 3. With thisinformation the Productivity Index - PI can be calculated. Thereafter the SPM will be further fine-tuned so as to remove the fluid pounding condition. This procedure requires that the load capability of the rod string and of the surface motor have been properly designed to enable the adjustment of the SPM either manually or automatically by meansof a VSD.

D) In the present invention a method is applied that enables the optimization of the Integrated Production System using the information extracted from the DC and data from sensors installed on the surface, thus going beyond the rod pump system. Giving that the downhole rod pump is just a subsystem of the Integrated Production System and is in continued interaction with the other two, the others being the Well-Reservoir System - called also he Inflow, and the Outflow System, changes on any of the other subsystems - that remain unnoticed, due to over focusing on the rod pump system only, will impact on the pump performance, thus missing improvement opportunities. FIG. 3 shows a schematic of the pressure Drop occurring on the said three Subsystems. In this application a method is presented that enables the optimization of the integrated production system that takes advantage of the generated and classified dynamometer cards that enable identification of a number of abnormal conditions or anomalies in the pump operation that affect or are caused by the other subsystems of the integrated production system IPS, as described in the detail description section. Further FIG. 3 depicts the three subsystems of the Integrated Production System - IPS, in the present invention a method is applied that enables the optimization of the Integrated Production System using data from sensors installed on the surface and the information extracted from the generated and classified dynamometer cards that enable identification of a number of abnormal conditions or anomalies in the pump operation that affect or are caused either by the rod pump subsystem or by the other subsystems of the integrated production system IPS. Thus the present application goes beyond the rod pump subsystem 2. To achieve this, first the characterization of the Subsystem of the Inflow performance of the Well Reservoir Subsystem 1 is carried out by determination of the wellbore flowing pressure Pfl without the need of downhole sensors nor from a fluid level surveys, and performing a well test or calculating the rate, what is described in [0059]. Another critical parameter that describes the inflow performance relationship - IPR, is the Bubble Point Pressure - Pb. This parameter depends on the composition of the crude oil and it is measured in the laboratory with fluid samples taking downhole or recombining the crude oil and the gas on the surface. Giving the associated complexity in obtaining this value, often times it is an unknown parameter. In the present application a determination method is presented that is done using the generated and classified DC, presented in this application in [0059]. Specifically, the point in time where the DC indicates the start of a gas interference condition, represents the physical effect of gas going out of solution at the point intake depth. By taking simultaneously a fluid level survey the Pb can be determined. It is to note that for unconventional wells attention should be paid to differentiate the condition of natural gas production of dissolved gas that goes out of solution from gas flow that is the result of the sinusoidal horizontal well trajectory what is reflected in a cyclical increased gas flow. Secondly based on the generated DC, a progressive increase in the load can be indicative of a diameter reduction in the flow conduit such as the tubing a key element of the Outflow 3. Depending on the historical data of the well, the performed diagnostic would call for a paraffin, asphaltene, sand, scale or salt treatment work to remove the obstruction. In any case the identification of this event triggers the use of treatment measures to remove the said diameter reduction of the flow conduit. Therefore, the performance of the downhole rod pump subsystem 3 can be better characterized on the basis of the changes in the parameters related to the elements of the other two subcomponents. Thus, considering all three subsystems of the Integrated Production System enables to unlock production increase opportunities as well as prevent pump or rod failures that otherwise would have been missed due to the sole focus on the downhole rod pump. As the above presented method enable the said improvements that result in the optimization of the Integrated Production System IPS, these features have been included in the algorithms that drives the Pump Controllers mentioned described in [0037] and [0038] and described further below, see also FIG. 5 and, FIG. 6.

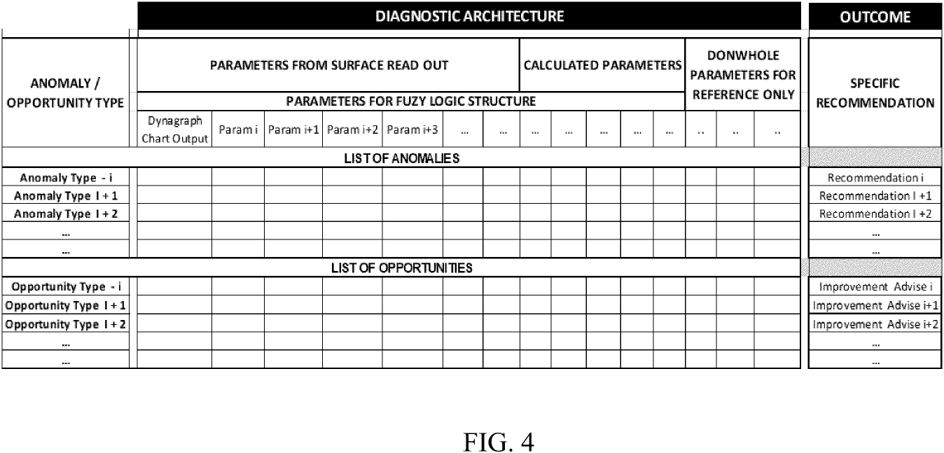

Referring to the FIG. 4, it depicts the operation anomaly and opportunity detection module built in the algorithm of the pump controller based on the invention of the present application. One of the purposes of this application is to have a reliable pump controller operation using an algorithm that is based on the generated and classified dynamometer cards and the parameters measured with the surface sensors only. In this context, the parameter data sourced from downhole sensors such as the downhole pressure, temperature or flow rate is considered as a secondary reference with no effect on the pump controller operation, due to the risk of sensor failure or communication disruption. The FIG. 4 shows the architecture of the automated identification of Anomalies affecting the subcomponents of the integrated production system, including the rod pump system as well as the identification of the production improvement opportunities that are available in the subject well.

FIG. 5 shows a schematic of the architecture of the Microcontroller based Pump Controller, that is powered by a battery loaded by solar panel. In this schematic the version for microcontrollers of the App Dyna Chart application is utilized - that is described in [0059]. FIG. 5 also shows components of the Rod Pump Surveillancer System - RPSS that is composed of a software module that incorporates both the dynamometer card generation and classification models, as contained in the App Dyna Chart along with the software that controls the pump operation that also takes data from other surface sensors into consideration and performs the optimization algorithm. It becomes evident that for low to very low oil producers less costly, yet robust rod pump controllers are required. The presented method enables the configuration of a Pump Controller that is based on a scalable application embedded in IoT - Internet of Things, based equipment that is robust, accurate and is driven by a software that can be operated at the site using Artificial Intelligence - AI as described in [0059], that yields accurate results, yet are run on devices with low computing capacity requirements such as microcontrollers, alternatively it can be also run in the cloud or in other external server. The algorithm for the said Pump Controller incorporates the architecture described in [0061] to identify the current operating conditions and production improvement opportunities as shown in FIG. 4, wherein the required input data is provided by the generated and classified dynamometer cards along with data from other surface sensors such as the Well Head Pressure Pwh, the Casing Pressure Pcs, the Flow Line Pressure Pfl, the Well Head Temperature Twh and a high resolution Microphone. A second microcontroller package is used as a redundant system that caters for any unexpected malfunctioning of the main microcontroller package. On the other side the utilized Fuzzy Logic Algorithm incorporates the said inventions enabling an online diagnostic and optimization of the rod pump system, as well as of the other two subsystems of the Integrated Production System, the Inflow and the Outflow - described in FIG. 3.

FIG. 6 Illustrates the schematic of the Architecture of the CPU - PLC - HMI based Pump Controller showing the components of the Rod Pump Surveillancer System -RPSS. The processing inside the CPU 1 is based on a set of rules and fuzzy logic structure in order to operate, monitor, troubleshoot and optimize the operation of the rod pump system. The presented set up expands the capability to identify abnormal pump operating conditions, it also supports the optimization of the integrated production system - as described in [0060], additionally it enables a full autonomous operation of the well using a Process Logic Control - PLC 4, the Human Machine Interphase - HMI 5, and the Ethernet communication protocol 2. Considering the associated advantages of the presented innovation it is up to the User to decide if it can be installed in the high profile wells and beyond. As shown in the FIG. , 4 the use of the downhole recorded data is considered as a reference only, and is not affecting the operation of the rod pump system in case of failure, as described in [0061], in order to have a reliable operation, despite any downhole sensor failure. Latest developments in PLC Technology incorporate an embedded microcontroller that can also be included in the present embodiment. As illustrated in the FIG. 1, in the present application the preferred embodiment incorporates an additional control device to the rod pump system, besides the use of the Variable Speed Drive - VSD 32, specifically a choke valve 19 with an actuator 18 on the flow line that is connected to the tubing. The related parameters such as the choke size and the differential pressure across the choke are added to the other surface parameters, to serve as input to the Computer Programmable Unit - CPU 1.

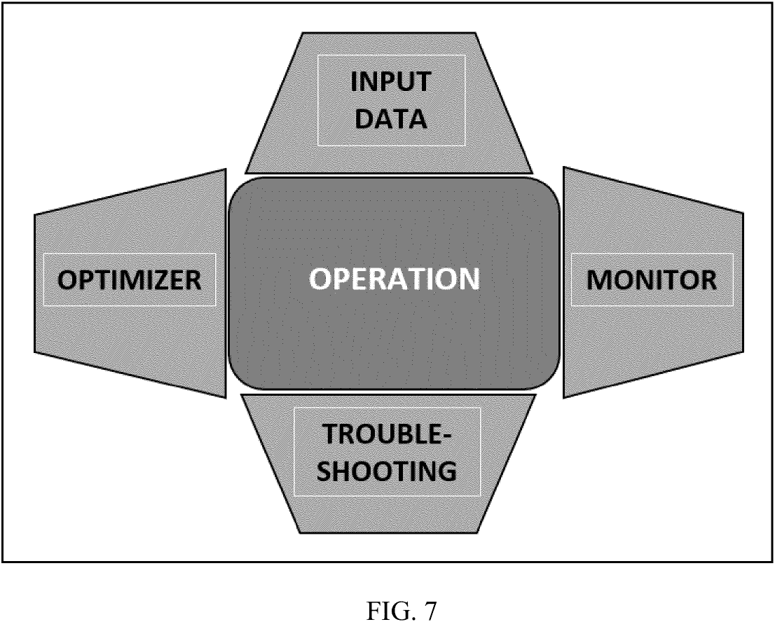

FIG. 7 illustrates the display of the menu as shown in the Human Machine Interphase - HMI comprising 5 sub-menus: Data Input, Monitor, Troubleshooting, Optimizer and Operation. The HMI device enables the users to enter the input data of the three subsystems of the Integrated Production System - IPS for the subject well. Further it shows the actual and trend of the key variables that enable to monitor the operation and shows the performed diagnostic of any anomaly that may be occurring or may be about to occur. Further in the menu are the Troubleshooting module that shows the recommended corrective action and the optimization module that shows the recommended action to increase oil production both are performed on autonomous mode in the preferred embodiment. The Operation Menu shows the default display of the key operating parameters, the dynamometer card and its classification and the result of the diagnostic and recommended corrective action as needed as well as the identified oil production improvement opportunity.

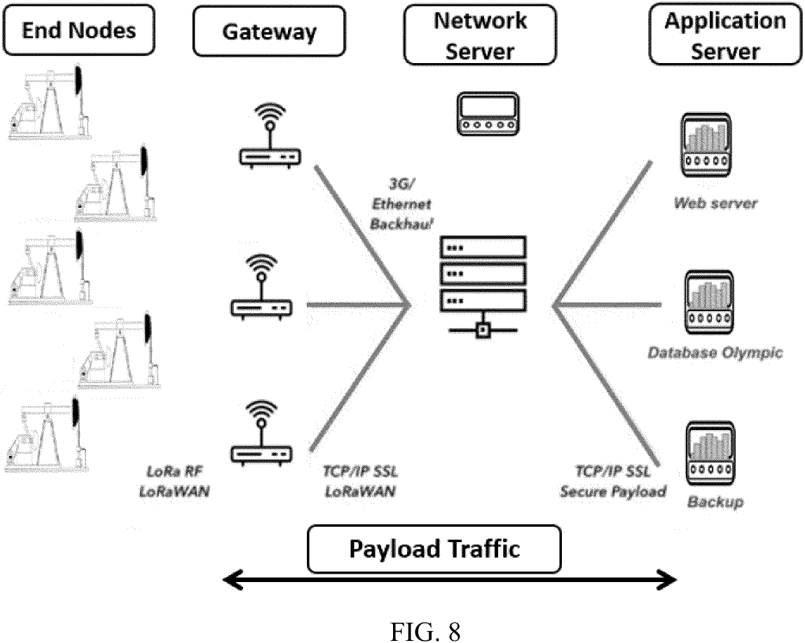

While the incorporated algorithm and control components enable a local operation, the remote operation requires that the data can be transmitted via internet, wifi,radio or satellite. For well locations where there is no internet connection at the site, a Low Power Wide Area Network (LPWAN) protocol such as the LoRaWAN™ can be utilized, which supports low-cost, mobile, and secure bi-directional communication for applications related to Internet of Things (IoT), machine-to-machine (M2M), such as the one of the present application. For the secure use of several pump controllers serving a group of wells, in the present embodiment a router, e.g. Gateway is utilized, that connects the End Nodes - the group of rod pump wells, with the Network Server. The connection to the Application Server ensures a secure payload traffic, e.g. via the TCP/IP SSL communication protocol. The said protocols provide full end-to-end encryption for IOT application, FIG. 8 shows a schematic of the data transmission and data traffic protection set up.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method, a computer program product, and a system for pump control that incorporates data from fit for purpose sensors, transducers, meters, artificial intelligence tools, optimization algorithms and subject matter expertise for autonomous optimization of a rod pump producing oil well, comprising:
a) a model to generate a Dynamometer Card based on data from two sensors, being the first one an accelerometer attached to the polished rod and the second one a positioning sensor attached to the horse head and a machine learning tool that enables a data-driven determination of the shape of the downhole dynamometer card using a database of real downhole dynamometer cards and Artificial Neural Network;
b) a model to classify Dynamometer Card based on the generated Dynamometer Card in 1a) and a Machine Learning tool that enables the diagnostic of the pump operating condition using a data base of real downhole dynamometer cards, labelled according to the prevailing operating condition as determined by a Subject or Domain Matter Expert, which may include one or a combination of two, three or of multiple operational conditions occurring at the same time during the operation of the pump and sucker rods, at a given point on time, e.g. fluid pounding only or fluid pounding and leaking standing valve or fluid pounding, leaking standing valve and pump plunger tagging up-stroke or down stroke, etc;
c) a program software for the programmable logic controller - PLC on the basis of Neural Fuzzy Logic, wherein the input data incorporates the by means of neural network generated and classified dynamometer card - 1a and 1b, measured parameters from reliable surface sensors and other calculated parameters, enabling autonomous optimization of the rod pump operation, by interacting with the variable speed drive-VSD, valve actuators, the start and stop switch, among others;
d) a Human Machine Interphase - HMI device that displays the menu comprising 5 sub-menus: Data Input, Monitor, Troubleshooting, Optimizer and Operation. It enables the users to enter the input data. Further it shows the actual and trend of the key variables that enable to monitor the operation and shows the performed diagnostic of any anomaly that may be occurring or may be about to occur. Further in the menu are the Troubleshooting module and the Optimization module, while the Operation menu is the default screen that provides an overview of the current status of the rod pump system; and
e) a computer program that is called here The Rod Pump Surveillancer - RPS System and is built in a Pump Controller that integrates a) and b) the models for generation and classification of the dynamometer cards, c) the algorithm and software program for the programmable logic controller - PLC and d) the program software for the Human Machine Interphase - HMI.

2. The method of claim 1, wherein the Dynamometer Card Generation and Classification models use data from two sensors; an Accelerometer - attached to the polished rod and a Positioning Sensor - installed on the horse head or above the saddle bearing, which are robust devices also known as Inertial Measurement Unit - IMU sensors, where the Positioning Sensor is comprised of both an Accelerometer and a Gyroscope. The said sensors can transmit the data to the Pump Controller via electrical cable, fiberglass, electrical cable, radio or wireless.

3. The method of claim 2, wherein both, the model that generates the dynamometer card - constructing the shape of the dynamometer card, and the model that performs the classification - predicting the type of operational condition that is occurring, utilize a neural network technique. Two versions have been implemented. One uses a machine learning model of supervised learning for applications that are executed in microcontrollers or low capacity microprocessors e.g. for local installation where there is no electrical power. The preferred embodiment uses a model developed with supervised and unsupervised deep learning as well as more robust variants of supervised and unsupervised machine learning, to be run in clusters, servers or high performance computers or CPUs at the well site.

4. The method of claim 2, wherein to perform the generation or classification models first an updated dynamometer card is recorded using a load cell or sensor and a positioning sensor - e. g. using the Echometer tool, when the present method is run in the subject well for the first time. This card is used for calibration purposes, thereafter the models carry on generating and classifying the dynamometer cards on a continuous basis. The generation rate of dynamometric charts depends on the strokes per minute -SPM of the unit, requiring at least two complete strokes to make a good data collection. During the initial calibration process two processing options are evaluated. The first one is in a batch form that first collects a sample of data and then process them to reconstruct the dynamometric chart and classify it, while the second one is done through a time series that implies acquiring the data continuously and making predictions based on a time space of at least a couple of strokes. It is to note that the load on the surface polished rod is determined comparing the dynamometer card recorded in the calibration phase with the generated dynamometer card, as the model generates the shape of the dynamometer card, it does not calculate the load.

5. The method of claim 2, wherein the required processing modules of the generation and classification models are described as follows: (a) The Real Time Clock - RTC, that allows to make a temporary trace to the register, for both, the classification and for the generation models. (b) The liquid-crystal display - LCD interface, that allows to view in the field the system data, such as time, date, the dynamometer card, the classification, the recommendation and the historical events of the day in the absence of a Human Machine Interphase - HMI. (c) The data acquisition module - DAQ that allows the synchronization of the request for information and the reception of data from the sensor. (d) The Data Manager, is a software module that allows managing the information (position and load), communicates with the cloud or the local processor in case the models run locally. (e) The Communication Module, e.g. the General Packet Radio Service - GRPS is a transmission module that uses the 3G cellular network to transmit and receive information from the cloud. It can transmit the raw information to be processed in the cloud or for local processing, in data packages. (f) The two Artificial Intelligence - IA Generation and Classification Models, that have been implemented in the present application, which can be executed in the cloud or locally, and are in charge of processing the information from the Data Manager, having as input the vector of acceleration and position characteristics.

6. The method of claim 2, wherein for the supervised Machine Learning the training data set for the model to generate the dynamometer card contains as input data the time in seconds, the load on the plunger in pounds, the acceleration in units of gravity - g, the positioning in the polish rod and the position on the plunger in inches. For the classification or the diagnostic part, the input contains and the dynamometer card labelling that indicates the type of prevailing operational condition of the pump and the sucker rods, as determined by a Subject Matter Expert. The considered operational conditions that are classified as part of the diagnostic module include among others the following conditions: fluid pound, gas interference, standing valve leakage, travelling valve leakage, broken rod, stretched rod, full load production, unanchored tubing, hole in barrel, plunger tag on up-stroke, plunger tag on down-stroke, worn pump, reduced tubing diameter, among others, as well as a combination of those conditions that could occur at the same time, e.g. two or three conditions.. Further the Training Set contains the same training parameters, yet from different wells. The initialization contains initial randomly generated weighting of the network. Further for the training of the Neural Network normalized and pretreated data is utilized, and as the Loss Function the Mean Square Error is used, that indicates the accuracy with respect to the real dynamometer card. Further a Gradient Descendent Optimizer is utilized to correct the initial weighting factor in such a way that as the Epochs pass the error decreases. Finally, the termination criteria is determined either by a number of Epochs or by the stabilization at a given low error value.

7. The method of claim 2, wherein for the supervised machine learning the training set for the model to classify the dynamometer card - a multi label classification, containsthe same features that the training of the model to generate the dynamometer card, except that the Loss Function is based on the Categorical Cross Entropy and that the termination criteria is based on achieving an accuracy above of 92%. Further the trainingprocess can also be carried out using other techniques such as supervised and unsupervised deep learning, and other techniques of recent and future development.

8. The method of claim 2, wherein the preferred embodiment for the wells where there is no electrical power available and the use of a battery and / or solar panel is needed, incorporates a microcontroller built in a transmission device that performs the reading of both sensors from claim 2 and performs the data pre-processing for the acceleration and the position as well as the extraction of the main characteristics, by dividing the recorded acceleration data into four blocks. From the entire register only onestroke is extracted according to the position register, this stroke is divided into four blockswith the same number of records each, from each group the main characteristics are extracted, which are inputs for both models - the Generation and the Classification Models. The information transfer to the field computer, e.g. CPU is transferred through the RS485 protocol, Modbus, or ethernet, among others.

9. The method of claim 2, wherein the preferred embodiment for the wells where electrical power is available, the field computer, e.g. CPU can perform the reading of both sensors from claim 2 and performs the data pre-processing for the acceleration and the position as well as the extraction of the main characteristics, by dividing the recorded acceleration data into four blocks and further feed it to the models for generation and classification of the dynamometer cards. Alternatively, more advanced programmable logic controllers - PLCs come with a CPU or microprocessor built in that can be suited toperform the above function.

10. The method of claim 2, wherein the dynamometer card results from a data-driven generated model, another embodiment incorporates data resulted of measurement of load, carried out using a cell attached to the polished rod that includes at least an ultrasound wave device to determine the deformation of the rod and therefore the load. Alternatively, this load can also be determined via the use of a cell attached to the polished rod that incorporates at least a camera and an image processing device to determine the deformation of the rod and therefore the load.

11. The method of claim 2, wherein both the Generation Model and the Classification Model configures an application called here - Dyna Chart App that is a system composed of hardware and software modules that allow both the generation of dynamometer cards and its automatic classification as described above. Further it also can be run on a standalone mode, without a pump controller.

12. The method of claim 1, wherein the programmable logic controller - PLC utilizes among others a Neural Fuzzy Logic Algorithm - NFLA. It improves the diagnostic and control capabilities, based on the integration of multiple parameters that enable the proper identification of the rod pump operation anomaly cases, and the problems affecting the other subcomponents of the Integrated Production System - IPS, the inflow and the outflow, as well as the Identification of Production Improvement opportunities.

13. The method of claim 12, wherein the input data for the Neural Fuzzy Logic Algorithm - NFLA includes the output of the generated and classified dynamometer cardusing neural network, the data recorded by reliable surface sensors and other calculatedparameters, in order to come up with specific recommendations that translate in optimized control measures, in contrast to other PLC only based solutions that have limitations withdata driven models using artificial intelligence - Al tools and rely on downhole sensors that are prone to fail or loss communication and are mainly focused on the downhole pump operation while neglecting the other subcomponents of the Integrated Production System.

14. The method of claim 1, wherein a Human Machine Interphase - HMI device displays the menu comprising modules related to the input data, monitoring, troubleshooting, optimization and the operational default display screen. It enables the users to enter the input data of the three subsystems of the Integrated Production System - IPS for the subject well. Further it shows the actual and trend values of the key variables that enable to monitor the operation and shows the performed diagnostic of any operational condition or conditions that may be occurring or may be about to occur. Further in the menu is the Troubleshooting module that shows the recommended corrective action and the optimization module that shows the recommended action to increase oil production both are performed on autonomous mode in the preferred embodiment.

15. The method of claim 1, wherein the computer program is called here The Rod Pump Surveillancer - RPS System and is built in a Pump Controller that integrates the models for generation and classification (or diagnostic) of the dynamometer cards, the algorithm program for the programmable logic controller - PLC, the microcontroller device, the edge computer and the program for the Human Machine Interphase - HMI.

16. The method of claim 15, wherein, specific algorithms are used to link all the components of the RPS System: CPU or Microcontroller, PLC, HMI, sensors, meters, valve actuators, VSD, the outcome of the generated and classified dynamometer cards and the determined parameters characterizing the three subcomponents of the integrated production system IPS - the reservoir, the pump and the outflow subsystems, such as the downhole flowing pressure Pwf, the liquid flow rate QI, the oil deferment, the flow conduct diameter above the rod pump, the effective pump volume, the pump wear, among others, as opposed to other systems that are constrained to the rod pump only.

17. The method of claim 15, wherein the hardware and software enable for ample range of application that goes from remote surveillance only to an onsite full autonomous optimization and anything in between, as required by the particular field application, and as justified by the production rate of the well. E.g. there is a configuration for low to very low rate wells and another one for high to very high rate producers. Further, the control capabilities of this application enables full autonomous pump operation by incorporating a Variable Speed Drive - VSD, flow line regulator valves and choke valves in the flow line and, or in the casing valve, wherein the choke valve can be operated by an electrical, pneumatic, or hydraulic driven actuator or adjusted manually on-site by the user, according to the recommendation of the pump controller software.

18. The method of claim 15, wherein for low rate wells and in the absence of a Variable Speed Drive - VSD, microcontrollers or processors and a Programmable Logic Controller - PLC can be incorporated on the wellsite to stop and start the well as determined by the built-in software. Whereby the PLC can also be a conventional one, or of the type that has at least an embedded microprocessor, or CPU built in.

19. The method of claim 15, wherein it can be used in versions for hardware based on a computer processing unit-CPU, microcontrollers, and on a programmable logic controller - PLC with a CPU (edge computer) or a microprocessor built in or embedded or a combination of them, E.g. for high rate wells. Alternatively, the software program called here The Rod Pump Surveillancer - RPS System can also be installed in a Variable Speed Drive-VSD and perform as an operating mode.

20. The method of claim 15, wherein it can be applied for a single well or for a group of wells by incorporating a distributed control system - DCS. Moreover, all the modules of the Rod Pump Surveillance - RPS System can be used or part of it, on the wellsite, the office server or in the cloud. It also can interact with other already existing systems in the user’s facilities that perform simplified tasks such as basic alarms, start-stop functions or parameter trend display.
